(19) United States
(12) Patent Application Publication
(10) Pub. No.: US 2005/0036306 A1
(43) Pub. Date: Feb. 17, 2005

(54) Flashlight having a power indication function

(76) Inventor: Chih-Ching Hsien, Taichung (TW)

Correspondence Address: Chih-Ching Hsien, 58, MA YUAN WEST ST., TAICHUNG, TW

(21) Appl. No.: 10/634,186

(22) Filed: Jul. 30, 2003

(51) Int. Cl. F21L 2/00

(52) U.S. Cl. 362/157

(57) ABSTRACT

A flashlight includes a main body having an inside formed with a receiving space, a power supply mounted in the receiving space of the main body, and a temperature sensing plate mounted on a periphery of the main body and electrically connected to the power supply in a parallel manner. Thus, the color of the temperature sensing plate is gradually changed, so that by the zone of the color variation of the temperature sensing plate, the electric power of the power supply can be detected, such that the user can identify magnitude of the electric power of the power supply.

### BACKGROUND OF THE INVENTION

1. Field of the Invention

The present invention relates to a flashlight, and more particularly to a flashlight having a power indication function.

2. Description of the Related Art

A conventional flashlight comprises a main body and a plurality of batteries mounted in the main body. However, if the batteries are still placed in the main body when not in use, the electric power of the batteries is largely consumed during a long period of time, so that the user cannot the residual electric power of the batteries. Thus, the flashlight is easily inoperative during a small period of time due to complete consumption of the electric power of the batteries, thereby causing inconvenience to the user.

### SUMMARY OF THE INVENTION

The primary objective of the present invention is to provide a flashlight having a power indication function.

Another objective of the present invention is to provide a flashlight, wherein the color of the temperature sensing plate is gradually changed from the shorter first end of the temperature sensing plate to the longer second end of the temperature sensing plate, so that by the zone of the color variation of the temperature sensing plate, the electric power of the power supply can be detected, such that the user can identify magnitude of the electric power of the power supply.

A further objective of the present invention is to provide a flashlight, wherein the temperature sensing plate co-operates with the indication portion, so as to exactly indicate the usable time that the residual electric power of the power supply can support.

A further objective of the present invention is to provide a flashlight, wherein when the electric power of the power supply is not large enough, the temperature sensing plate produces smaller heat energy, so that the zone of the color variation is not full of the temperature sensing plate, thereby facilitating the user identifying the residual electric power of the power supply.

A further objective of the present invention is to provide a flashlight, wherein the temperature sensing plate used to function as a power detection member of the power supply has a cheaper price, thereby decreasing costs of fabrication.

In accordance with the present invention, there is provided a flashlight, comprising:

a main body having an inside formed with a receiving space;

a power supply mounted in the receiving space of the main body; and

a temperature sensing plate mounted on a periphery of the main body and electrically connected to the power supply in a parallel manner.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a flashlight in accordance with the preferred embodiment of the present invention;

FIG. 2 is a top plan view of a temperature sensing plate of the flashlight in accordance with the preferred embodiment of the present invention;

FIG. 3 is a plan cross-sectional assembly view of the flashlight as shown in FIG. 1;

FIG. 4 is a perspective assembly operational view of the flashlight as shown in FIG. 1;

FIG. 5 is a schematic operational view of the temperature sensing plate of the flashlight as shown in FIG. 2 in use; and

FIG. 6 is a block view of the circuit of the flashlight in accordance with the preferred embodiment of the present invention.

### DETAILED DESCRIPTION OF THE INVENTION

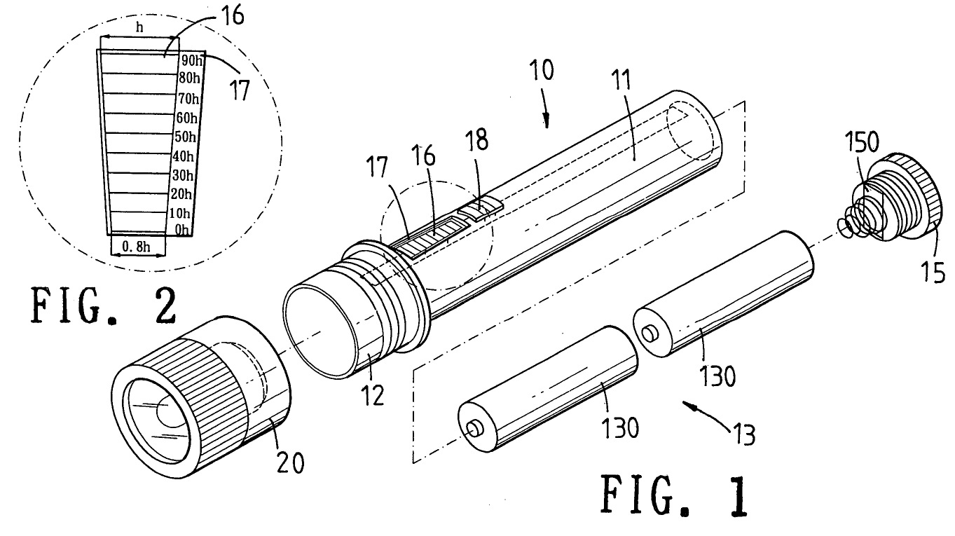

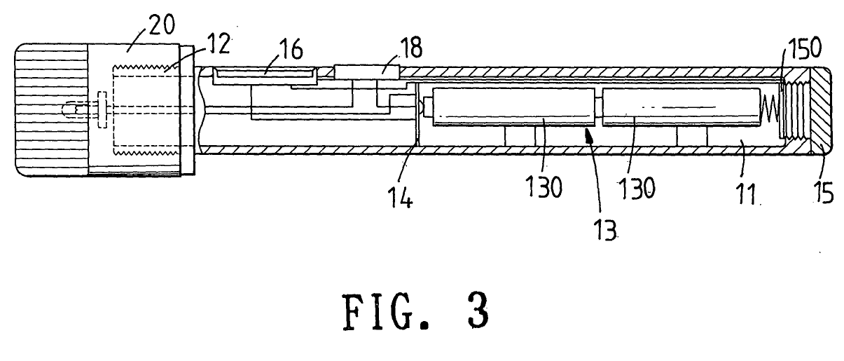

Referring to the drawings and initially to FIGS. 1-3, a flashlight in accordance with the preferred embodiment of the present invention comprises a main body 10 having an inside formed with a receiving space 11, an illumination device 20 mounted on a first end 12 of the main body 10, a first conductive plate 14 (see FIG. 3) mounted in the receiving space 11 of the main body 10, a cover 15 mounted on a second end of the main body 10 and having a side provided with a second conductive plate 150 communicated with the receiving space 11 of the main body 10, a power supply 13 mounted in the receiving space 11 of the main body 10 and having a positive side connected to the first conductive plate 14 and a negative side connected to the second conductive plate 150, and a switch 18 mounted on the main body 10 to control connection between the illumination device 20 and the power supply 13. Preferably, the power supply 13 includes two batteries 130.

The flashlight further comprises a temperature sensing plate 16 mounted on a periphery of the main body 10 and electrically connected to the power supply 13 in a parallel manner. Preferably, the temperature sensing plate 16 has a substantially trapezoid shape. In addition, the temperature sensing plate 16 has a first end and a second end having a width greater than that of the first end, so that the temperature sensing plate 16 has a width gradually increased from the first end to the second thereof.

The flashlight further comprises an indication portion 17 mounted on the periphery of the main body 10 and located beside the temperature sensing plate 16. Preferably, the indication portion 17 has a start point (0h) aligning with the first end of the temperature sensing plate 16.

In operation, the temperature sensing plate 16 is used to function as a power detection member of the power supply 13.

In practice, the temperature sensing plate 16 is electrically connected to the power supply 13 in a parallel manner, thereby forming a short circuit when the switch 18 is started. At this time, the temperature of the temperature sensing plate 16 is increased due to heat, so that the color of the temperature sensing plate 16 is changed to produce color variation.

In addition, the temperature sensing plate 16 has a trapezoid shape, so that the two ends of the temperature sensing plate 16 have two different resistance values. The resistance value is inverse proportional to the cross-sectional area under the same material and length. That is, R=P×L/A, wherein R is the resistance value, L is the length, and A is the cross-sectional area. Thus, the shorter first end of the temperature sensing plate 16 has a resistance greater than that of the longer second end of the temperature sensing plate 16. In addition, P=I²×R, wherein P is the power, and I is the current. At this time, the current passing through the temperature sensing plate 16 is a constant, so that the power P is proportional to the resistance R, and the shorter first end of the temperature sensing plate 16 has a power greater than that of the longer second end of the temperature sensing plate 16.

Thus, the color of the temperature sensing plate 16 is gradually changed from the shorter first end of the temperature sensing plate 16 to the longer second end of the temperature sensing plate 16. In such a manner, by the zone of the color variation of the temperature sensing plate 16, the electric power of the power supply 13 can be detected, so that the user can identify magnitude of the electric power of the power supply 13.

In addition, the temperature sensing plate 16 co-operates with the indication portion 17, so as to exactly indicate the usable time that the residual electric power of the power supply 13 can support.

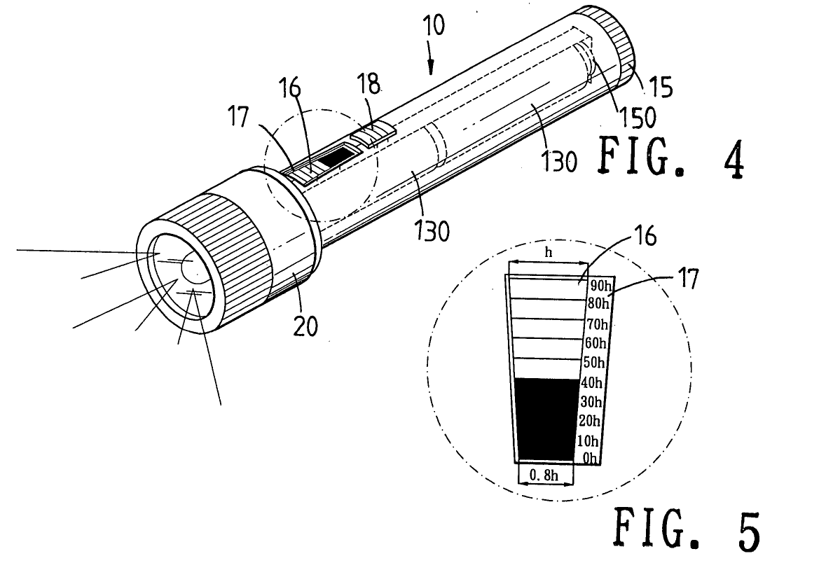

Referring to FIGS. 4 and 5, when the electric power of the power supply 13 is not large enough, the temperature sensing plate 16 produces smaller heat energy, so that the zone of the color variation is not full of the temperature sensing plate 16, thereby facilitating the user identifying the residual electric power of the power supply 13.

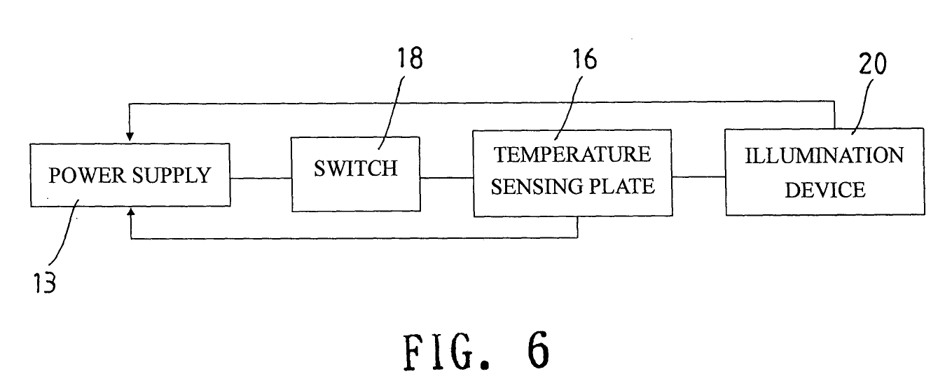

FIG. 6 shows the block view of the circuit of the flashlight in accordance with the preferred embodiment of the present invention.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A flashlight, comprising:
a main body having an inside formed with a receiving space;
a power supply mounted in the receiving space of the main body; and
a temperature sensing plate mounted on a periphery of the main body and electrically connected to the power supply in a parallel manner.

2. The flashlight in accordance with claim 1, wherein the temperature sensing plate has a substantially trapezoid shape.

3. The flashlight in accordance with claim 1, wherein the temperature sensing plate has a first end and a second end having a width greater than that of the first end, so that the temperature sensing plate has a width gradually increased from the first end to the second thereof.

4. The flashlight in accordance with claim 1, wherein the further comprising an indication portion mounted on the periphery of the main body 10 and located beside the temperature sensing plate.

5. The flashlight in accordance with claim 4, wherein the indication portion has a start point aligning with the first end of the temperature sensing plate.

6. The flashlight in accordance with claim 4, wherein the temperature sensing plate co-operates with the indication portion, so as to exactly indicate the usable time that the residual electric power of the power supply can support.

7. The flashlight in accordance with claim 1, wherein the temperature sensing plate is used to function as a power detection member of the power supply.

8. The flashlight in accordance with claim 1, further comprising an illumination device mounted on a first end of the main body, and a switch mounted on the main body to control connection between the illumination device and the power supply.

9. The flashlight in accordance with claim 8, wherein the switch is started to form a short circuit, so that the temperature of the temperature sensing plate is increased, and the temperature sensing plate is heated to produce color variation.

10. The flashlight in accordance with claim 1, further comprising a first conductive plate mounted in the receiving space of the main body, a cover mounted on a second end of the main body and having a side provided with a second conductive plate communicated with the receiving space of the main body.

11. The flashlight in accordance with claim 10, wherein the power supply has a positive side connected to the first conductive plate and a negative side connected to the second conductive plate.

12. The flashlight in accordance with claim 3, wherein the color of the temperature sensing plate is gradually changed from the shorter first end of the temperature sensing plate to the longer second end of the temperature sensing plate.

13. The flashlight in accordance with claim 1, wherein by the zone of the color variation of the temperature sensing plate, the electric power of the power supply can be detected, so that the user can identify magnitude of the electric power of the power supply.
